(19) United States
(12) Patent Application Publication
(10) Pub. No.: US 2015/0221942 A1
(43) Pub. Date: Aug. 6, 2015

(54) POSITIVE ELECTRODE ACTIVE MATERIAL FOR NONAQUEOUS ELECTROLYTE SECONDARY BATTERY AND NONAQUEOUS ELECTROLYTE SECONDARY BATTERY INCLUDING THE SAME

(71) Applicant: SANYO Electric Co., Ltd., Daito-shi, Osaka (JP)

(72) Inventors: Junichi Sugaya, Osaka (JP); Manabu Takijiri, Osaka (JP); Masanobu Takeuchi, Hyogo (JP); Katsunori Yanagida, Hyogo (JP); Takeshi Ogasawara, Hyogo (JP)

(73) Assignee: SANYO Electric Co., Ltd., Daito-shi, Osaka (JP)

(21) Appl. No.: 14/420,718

(22) PCT Filed: Aug. 28, 2013
(86) PCT No.: PCT/JP2013/005076

§ 371 Date: Feb. 10, 2015

(30) Foreign Application Priority Data
Sep. 28, 2012 (JP) 2012-218005

(51) Int. Cl. H01M 4/525; H01M 10/0525

(52) U.S. Cl. CPC H01M 4/525; H01M 10/0525; H01M 2004/028

(57) ABSTRACT

A positive electrode active material for a nonaqueous electrolyte secondary battery includes a lithium transition metal oxide containing nickel and zirconium and including secondary particles, each of which is composed of an aggregate of primary particles, and a rare earth compound deposited on and/or near interfaces between the primary particles.

### TECHNICAL FIELD

The present invention relates to positive electrode active materials for nonaqueous electrolyte secondary batteries and to nonaqueous electrolyte secondary batteries including such positive electrode active materials.

### BACKGROUND ART

Recent years have seen a significant reduction in the size and weight of mobile information terminals such as cellular phones, laptop computers, and smart phones, and there is a need for a battery with a higher capacity as their power supply. Nonaqueous electrolyte secondary batteries in which lithium ions move between positive and negative electrodes during charge and discharge have high energy density and high capacity and thus are widely used as power supplies for the mobile information terminals as described above.

Recently, nonaqueous electrolyte secondary batteries have also received attention as power supplies for power applications such as electric tools and electric vehicles and have been expected to find a broader range of applications. The power supplies for such power applications require a higher capacity for extended use and better cycle characteristics for high-current discharge repeated at relatively short intervals. In particular, it is essential for the applications such as electric tools and electric vehicles to achieve a higher capacity while maintaining the cycle characteristics after high-current discharge.

One known approach for increasing the battery capacity is to broaden the operating voltage range by increasing the charge voltage. This approach, however, is disadvantageous in that an increase in charge voltage increases the oxidizing power of the positive electrode active material. The positive electrode active material, which contains catalytic transition metals (e.g., cobalt, manganese, nickel, and iron), causes reactions such as the decomposition of the electrolyte solution. As a result, a film of transition metal oxide containing cations such as Co²⁺ and Ni²⁺, which inhibit the charge-discharge reaction, forms on the surface of the positive electrode active material. Accordingly, the following proposals have been made:

(1) a proposal to provide an oxide such as gadolinium oxide on the surface of matrix particles capable of absorbing and releasing lithium ions to reduce the increase in floating current during high-temperature charge (see PTL 1); and

(2) a proposal to provide a larger amount of element such as zirconium near the surface of the secondary particles of the positive electrode active material to improve the cycle characteristics and the storage characteristics (see PTL 2).

### CITATION LIST

### Patent Literature

PTL 1: International Publication No. WO2005/008812

PTL 2: Japanese Published Unexamined Patent Application No. 2006-202647

### SUMMARY OF INVENTION

### Technical Problem

Unfortunately, the above proposals (1) and (2) have the following problem. During high-current discharge, the positive electrode active material cracks and exposes fresh surfaces of primary particles, on which a side reaction between the positive electrode active material and the electrolyte solution cannot be sufficiently inhibited. This reaction decreases the battery capacity and thus decreases the cycle characteristics and the power characteristics after repeated high-current discharge.

### Solution to Problem

A positive electrode active material for a nonaqueous electrolyte secondary battery according to an aspect of the present invention includes a lithium transition metal oxide containing nickel and zirconium and including secondary particles, each of which is composed of an aggregate of primary particles, and a rare earth compound deposited on and/or near interfaces between the primary particles.

### Advantageous Effects of Invention

According to the aspect of the present invention, it is possible to improve the cycle characteristics and reduce the decrease in power characteristics after repeated charge and discharge under conditions involving high-current discharge.

### BRIEF DESCRIPTION OF DRAWINGS

FIG. 1 is a schematic longitudinal sectional view showing the general structure of a cylindrical nonaqueous electrolyte secondary battery according to an embodiment of the present invention.

### DESCRIPTION OF EMBODIMENTS

An embodiment of the present invention includes a lithium transition metal oxide containing nickel and zirconium and including secondary particles, each of which is composed of an aggregate of primary particles, and a rare earth compound deposited on and/or near interfaces between the primary particles.

If the lithium transition metal oxide is present in the form of secondary particles and has a rare earth compound deposited on and/or near the interfaces between the primary particles, the zirconium contained in the lithium transition metal oxide and the rare earth compound are present on and/or near the interfaces. These components form a stable structure on and/or near the interfaces and thus inhibit cracking of the secondary particles during high-current discharge for the reason described later. This improves the cycle characteristics and reduces the decrease in power characteristics after repeated charge and discharge under conditions involving high-current discharge. Thus, the battery according to the embodiment of the present invention is significantly useful for applications, such as tools, that require discharge at high currents, e.g., from 10 to 20 A.

Zirconium may be present, for example, uniformly in the primary particles of the lithium transition metal oxide, in larger amounts on the surface of the primary particles and/or in the surface layer thereof (i.e., in the primary particles near the surface thereof), or in larger amounts on the surface of the secondary particles and/or in the surface layer thereof.

The lithium transition metal oxide is preferably represented by the formula LiₓNi_{y}Zr_{z}M_{(1-y-z)}O₂ (where 0.9<x<1.2, 0.3<y≦0.9, and 0.001≦z ≦0.01).

The value of x is preferably 0.9<x<1.2, more preferably 0.98<x<1.05. A value of x of 0.95 or less decreases the stability of the crystal structure and thus makes it difficult to sufficiently maintain the capacity and reduce the decrease in power characteristics after cycling. A value of x of 1.2 or more results in increased gas emission.

The value of y is limited to the above range. A value of y of 0.3 or less decreases the discharge capacity. A value of y of more than 0.9 decreases the stability of the crystal structure and thus makes it difficult to sufficiently maintain the capacity and reduce the decrease in power characteristics after cycling.

The value of z is preferably 0.001≦z≦0.01, more preferably 0.003≦z≦0.007. A value of z of less than 0.001 decreases the effectiveness of zirconium. A value of z of more than 0.01 decreases the discharge capacity.

In particular, the lithium transition metal oxide is preferably represented by the formula LiₓNi_{y}Zr_{z}CoₐMn_{b}Al_{(1-y-z-a-b)}O₂ (where 0.9<x<1.2, 0.3<y≦0.9, 0.001≦z≦0.01, y-b>0.03, and 0≦b≦0.5).

The value of y-b is limited to y-b>0.03. It is desirable that the value of y-b be 0 or more because a high proportion of manganese forms impurity phases and thus decreases the capacity and the power.

The lithium transition metal oxide preferably has a primary particle size of from 0.2 to 2 μm, more preferably from 0.5 to 1 μm. A primary particle size of less than 0.2 μm results in a large number of interfaces between the primary particles and thus decreases the proportion of rare earth compound deposited on and/or near the interfaces between the primary particles. This may result in insufficient formation of a stable structure on the surface of the primary particles of the lithium transition metal oxide and thus make it difficult to sufficiently improve the cycle characteristics and reduce the decrease in power characteristics. A primary particle size of more than 2 μm results in a long diffusion distance of lithium ions in the lithium transition metal oxide during high-current discharge and thus decreases the power characteristics.

The rare earth compound is preferably a rare earth hydroxide, a rare earth oxyhydroxide, or a rare earth oxide, more preferably a rare earth hydroxide or a rare earth oxyhydroxide. The use of these compounds enhances the advantageous effects described above. These rare earth compounds may be used in combination with other rare earth compounds such as rare earth carbonates and rare earth phosphates.

Examples of rare earth elements contained in the rare earth compounds include scandium, yttrium, lanthanum, cerium, praseodymium, neodymium, samarium, europium, gadolinium, terbium, dysprosium, holmium, erbium, thulium, ytterbium, and lutetium. Particularly preferred are neodymium, samarium, and erbium. Neodymium compounds, samarium compounds, and erbium compounds have smaller average particle sizes than other rare earth compounds and thus precipitate more uniformly on the surface of the positive electrode active material.

Examples of such rare earth compounds include neodymium hydroxide, neodymium oxyhydroxide, samarium hydroxide, samarium oxyhydroxide, erbium hydroxide, and erbium oxyhydroxide. The use of lanthanum hydroxide or lanthanum oxyhydroxide as the rare earth compound reduces the manufacturing cost of the positive electrode since lanthanum is less expensive.

The rare earth compound preferably has an average particle size of from 1 to 100 nm. A rare earth compound having an average particle size of more than 100 nm has an extremely large particle size and thus includes fewer particles. This decreases the likelihood of the rare earth compound being deposited on and/or near the interfaces between the primary particles.

A rare earth compound having an average particle size of less than 1 nm extremely densely covers the surface of the lithium transition metal oxide particles. This decreases the ability of the surface of the lithium transition metal oxide particles to absorb and release lithium ions and thus decreases the charge-discharge characteristics. In view of the foregoing, the rare earth compound more preferably has an average particle size of from 10 to 50 nm.

The rare earth compound, such as erbium oxyhydroxide, may be deposited on the lithium transition metal oxide, for example, by mixing an aqueous solution of a rare earth salt such as an erbium salt with a dispersion of the lithium transition metal oxide to deposit the rare earth salt on the surface of the lithium transition metal oxide, followed by heat treatment. The heat treatment temperature is preferably from 120° C. to 700° C., more preferably from 250° C. to 500° C. A heat treatment temperature lower than 120° C. may be insufficient to remove water adsorbed onto the active material and thus leave water in the battery. A heat treatment temperature higher than 700° C. causes the rare earth compound to diffuse from the surface of the active material into the interior thereof. This leaves little rare earth compound on the surface of the active material and thus decreases the effectiveness of the rare earth compound. In particular, a heat treatment temperature of from 250° C. to 500° C. facilitates removal of water while leaving the rare earth compound selectively deposited on the surface of the active material. A heat treatment temperature higher than 500° C. may cause some rare earth compound to diffuse from the surface of the active material into the interior thereof and thus decrease the effectiveness of the rare earth compound. An alternative method is by spraying an aqueous solution of a rare earth salt (e.g., an erbium salt) while mixing it with the lithium transition metal oxide and then drying the lithium transition metal oxide. Another alternative method is by mixing the lithium transition metal oxide and the rare earth compound using a mixer to mechanically deposit the rare earth compound on the surface of the lithium transition metal oxide. These alternative methods may be followed by heat treatment. In this case, the heat treatment temperature may be similar to that used in the method including mixing an aqueous solution.

Preferred among these methods are the method including mixing an aqueous solution of a rare earth salt such as an erbium salt with a dispersion of the lithium transition metal oxide and the method including spraying an aqueous solution of a rare earth salt while mixing it with the lithium transition metal oxide. Particularly prepared is the method including mixing an aqueous solution of a rare earth salt such as an erbium salt with a dispersion of the lithium transition metal oxide. With this method, the rare earth compound can be more uniformly dispersed and deposited on the surface of the lithium transition metal oxide. The dispersion of the lithium transition metal oxide is preferably adjusted to a predetermined pH. In particular, the dispersion of the lithium transition metal oxide is preferably adjusted to a pH of from 6 to 10, at which fine particles having particle sizes of from 1 to 100 nm can be uniformly dispersed and precipitated on the surface of the lithium transition metal oxide. A pH of less than 6 may result in dissolution of transition metals from the lithium transition metal oxide, whereas a pH of more than 10 may result in segregation of the rare earth compound.

The rare earth element is preferably present in an amount of from 0.003 to 0.25 mol % based on the total number of moles of transition metals in the lithium transition metal oxide. Less than 0.003 mol % rare earth element may be insufficiently effective. More than 0.25 mol % rare earth compound may lower the reactivity of the surface of the lithium transition metal oxide particles and thus decrease the cycle characteristics for high-current discharge.

### (Other Considerations)

(1) The solvent used for the nonaqueous electrolyte may be any solvent, including those conventionally used in nonaqueous electrolyte secondary batteries. Examples of such solvents include cyclic carbonates such as ethylene carbonate, propylene carbonate, butylene carbonate, and vinylene carbonate; chain carbonates such as dimethyl carbonate, ethyl methyl carbonate, and diethyl carbonate; ester-containing compounds such as methyl acetate, ethyl acetate, propyl acetate, methyl propionate, ethyl propionate, and γ-butyrolactone; sulfo-containing compounds such as propane sultone; ether-containing compounds such as 1,2-dimethoxylethane, 1,2-diethoxyethane, tetrahydrofuran, 1,2-dioxane, 1,4-dioxane, and 2-methyltetrahydrofuran; nitrile-containing compounds such as butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile; and amide-containing compounds such as dimethylformamide. In particular, solvents partially substituted with fluorine are preferred. These solvents may be used alone or in combination. Particularly preferred are combinations of cyclic carbonates and chain carbonates and combinations thereof with small amounts of nitrile-containing compounds and ether-containing compounds.

Alternatively, the nonaqueous solvent used for the nonaqueous electrolyte may be an ionic liquid. The ionic liquid may be composed of any cation and any anion. In particular, combinations of pyridinium, imidazolium, and quaternary ammonium cations with fluoroimide anions are preferred for their low viscosity, electrochemical stability, and hydrophobicity.

The solute used for the nonaqueous electrolyte may be a known lithium salt conventionally and commonly used in nonaqueous electrolyte secondary batteries. Examples of such lithium salts include lithium salts containing at least one element selected from phosphorus, boron, fluorine, oxygen, sulfur, nitrogen, and chlorine. Specific examples include lithium salts such as LiPF₆, LiBF₄, LiCF₃SO₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃, LiAsF₆, LiClO₄, LiPF₂O₂, and mixtures thereof. In particular, LiPF₆ is preferred to improve the high-rate charge-discharge characteristics and durability of the nonaqueous electrolyte secondary battery.

Alternatively, the solute may be a lithium salt containing an oxalato complex as the anion. The lithium salt containing an oxalato complex as the anion may be lithium bisoxalate borate (LiBOB) or a lithium salt containing an anion having C₂O₄²⁻ coordinated to the central atom thereof, for example, a compound represented by the formula Li[M(C₂O₄)ₓR_{y}] (where M is a transition metal or an element selected from Groups 13, 14, and 15 in the periodic table; R is a group selected from halogen, alkyl, and halogenated alkyl; x is a positive integer; and y is 0 or a positive integer). Specific examples include Li[B(C₂O₄)F₂], Li[P(C₂O₄)F₄], and Li[P(C₂O₄)₂F₂]. LiBOB is most preferred to form a stable coating on the surface of the positive electrode in a high-temperature environment.

These solutes may be used alone or in a mixture of two or more. The solute concentration is preferably, but not necessarily, 0.8 to 1.7 mol per litter of the electrolyte solution. For applications requiring discharge at high current, the solute concentration is preferably 1.0 to 1.6 mol per litter of the electrolyte solution.

(2) The negative electrode active material may be any negative electrode active material capable of reversibly absorbing and releasing lithium. Examples of such negative electrode active materials include carbonaceous materials, metal and alloy materials capable of alloying with lithium, and metal oxides. For reasons of material cost, carbonaceous materials are preferred as the negative electrode active material. Examples of carbonaceous materials include natural graphite, synthetic graphite, mesophase pitch-based carbon fiber (MCF), mesocarbon microbeads (MCMB), coke, and hard carbon. In particular, low-crystallinity-carbon-coated graphite materials are preferred as the negative electrode active material to improve the high-rate charge-discharge characteristics.

(3) The separator may be a conventionally used separator. Examples of such separators include polyethylene separators, polyethylene separators having a polypropylene layer thereon, and polyethylene separators coated with an aramid resin.

(4) A conventionally used inorganic-filler containing layer may be formed between the positive electrode and the separator or between the negative electrode and the separator. The inorganic-filler containing layer may contain conventionally used fillers, including oxides and phosphates of one or more metals such as titanium, aluminum, silicon, and magnesium and those surface-treated with compounds such as hydroxides. The filler layer may be formed, for example, by directly applying a filler-containing slurry to the positive electrode, the negative electrode, or the separator, or by laminating a sheet formed using the filler on the positive electrode, the negative electrode, or the separator.

### EXAMPLES

The embodiment of the present invention is further illustrated by the following specific examples, although these examples are not intended to limit the present invention; it can be practiced with various modifications without departing from the spirit thereof.

### EXAMPLE

### [Synthesis of Positive Electrode Active Material]

A raw material solution was prepared by dissolving 1,600 g of a mixture of nickel sulfate, cobalt sulfate, and manganese sulfate in an atomic ratio of nickel, cobalt, and manganese of 55:20:25 in 5 L of water. To the raw material solution, 200 g of sodium hydroxide was added to form a precipitate. The precipitate was sufficiently washed with water and was dried to obtain a coprecipitated transition metal hydroxide.

The coprecipitated transition metal hydroxide was fired at 750° C. for 12 hours to obtain a transition metal oxide. After 1,000 g of the resulting transition metal oxide was mixed with 515 g of Li₂CO₃ and 8.4 g of ZrO₂, the mixture was fired at 950° C. for 12 hours to obtain a lithium transition metal oxide. XRD showed that the resulting lithium transition metal oxide was a single phase with space group R3-m. ICP optical emission spectroscopy showed that the composition was LiNi_{0.545}Co_{0.20}Mn_{0.25}Zr_{0.005}O₂. SEM examination showed that the lithium transition metal oxide included secondary particles, each of which was composed of an aggregate of primary particles (which had an average particle size of 0.7 μm as determined by SEM examination). The secondary particles had an average particle size (D50) of 14 μm. The average particle size (D50) of the secondary particles was determined using a laser diffraction particle size analyzer by adding together the masses of the particles in order of increasing particle size and calculating the particle size at which the cumulative mass was 50% of the total mass of the particles.

After 1,000 g of the lithium transition metal oxide particles synthesized by the above procedure were added to 3 L of pure water and the mixture was stirred, a solution of 4.58 g of erbium nitrate pentahydrate was added to the mixture. The solution containing the lithium transition metal oxide was adjusted to a pH of 9 by adding an appropriate amount of a 10% by mass solution of sodium hydroxide in water. The lithium transition metal oxide was suction-filtered, was washed with water, and was fired at 400° C. for 5 hours. The resulting powder was dried to obtain a positive electrode active material having erbium oxyhydroxide uniformly deposited on the surface of the lithium transition metal oxide. The amount of deposited erbium oxyhydroxide calculated on an elemental erbium basis was 0.1 mol % based on the total number of moles of transition metal in the lithium transition metal oxide. SEM examination of the resulting positive electrode active material showed that the lithium transition metal oxide had erbium oxyhydroxide deposited on and/or near the interfaces between the primary particles.

### [Fabrication of Positive Electrode]

A positive electrode slurry was prepared by mixing 94 parts by mass of the positive electrode active material with 4 parts by mass of carbon black, serving as a carbon conductor, and 2 parts by mass of poly(vinylidene fluoride), serving as a binder, and adding an appropriate amount of N-methyl-2-pyrrolidone (NMP). The positive electrode slurry was applied to both surfaces of a positive electrode current collector made of aluminum and was dried. Finally, the coated current collector was cut to a predetermined electrode size, was rolled with a roller, and was equipped with a positive electrode lead to obtain a positive electrode.

### [Fabrication of Negative Electrode]

A negative electrode slurry was prepared by mixing 97.5 parts by mass of synthetic graphite, serving as a negative electrode active material, 1 part by mass of carboxymethyl cellulose, serving as a thickener, and 1.5 parts by mass of styrene-butadiene rubber, serving as a binder, and adding an appropriate amount of pure water. The negative electrode slurry was applied to both surfaces of a negative electrode current collector made of copper foil and was dried. Finally, the coated current collector was cut to a predetermined electrode size, was rolled with a roller, and was equipped with a negative electrode lead to obtain a positive electrode.

### [Preparation of Nonaqueous Electrolyte Solution]

A nonaqueous electrolyte solution was prepared by dissolving LiPF₆, serving as a solute, in a mixture of ethylene carbonate (EC), methyl ethyl carbonate (MEC), dimethyl carbonate (DMC), propylene carbonate (PC), and fluoroethylene carbonate (FEC) in a volume ratio of 10:10:65:5:10 in a concentration of 1.5 mol/L and adding vinylene carbonate (VC) in an amount of 1% by weight of the total weight of the nonaqueous electrolyte solution.

### [Fabrication of Battery]

The positive electrode and the negative electrode were placed opposite each other with a separator made of a polyethylene fine porous film and were spirally rolled around a core. The core was then removed to obtain a spiral electrode assembly. After the electrode assembly was inserted into a metal casing, the nonaqueous electrolyte solution was injected and sealed in the metal casing to obtain a 18650 nonaqueous electrolyte secondary battery having a diameter of 18 mm and a height of 65 mm (theoretical capacity: 2.0 Ah).

The thus-fabricated battery is hereinafter referred to as Battery A.

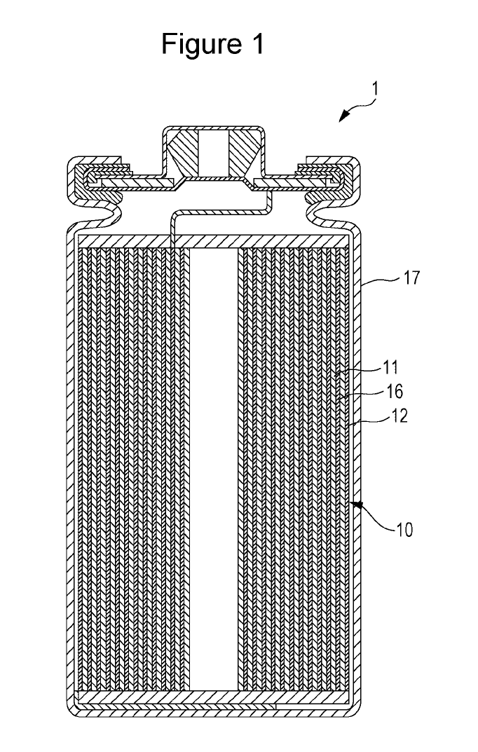

FIG. 1 is a schematic sectional view of the nonaqueous electrolyte secondary battery fabricated as described above, where reference sign 1 indicates a nonaqueous electrolyte secondary battery, reference sign 10 indicates an electrode assembly, reference sign 11 indicates a positive electrode, reference sign 12 indicates a negative electrode, reference sign 16 indicates a separator, and reference sign 17 indicates a battery container.

### Comparative Example 1

A battery was fabricated as in the Example except that no erbium oxyhydroxide was deposited on the surface of the lithium transition metal oxide during the synthesis of the positive electrode active material.

The thus-fabricated battery is hereinafter referred to as Battery Z1.

### Comparative Example 2

A battery was fabricated as in the Example except that the lithium transition metal oxide was fired without being mixed with ZrO₂ during the synthesis of the positive electrode active material.

The thus-fabricated battery is hereinafter referred to as Battery Z2.

### Comparative Example 3

A battery was fabricated as in the Example except that the lithium transition metal oxide was fired without being mixed with ZrO₂ and no erbium oxyhydroxide was deposited on the surface of the lithium transition metal oxide during the synthesis of the positive electrode active material.

The thus-fabricated battery is hereinafter referred to as Battery Z3.

### (Experiment)

Batteries A and Z1 to Z3 were repeatedly charged and discharged under the following conditions to examine the number of cycles to a capacity retention of 70% and the increase in resistance represented by equation (1) below (increase in resistance after 150 cycles). The results are shown in Table 1.

### Charge-Discharge Conditions

At 25° C., the batteries were charged at a constant charge current of 2.0 It (4.0 A) to a battery voltage of 4.35 V, were charged at a constant battery voltage of 4.35 V to a current of 0.02 It (0.04 A), and were discharged at a constant discharge current of 10.0 It (20.0 A) to a voltage of 2.5 V.

### Formula for Calculation of Increase in Resistance

Increase in resistance={(discharge voltage 1 second after start of discharge in 150th cycle)−(discharge voltage 1 second after start of discharge in 1st cycle)}/(discharge current) (1)

TABLE 1

| | Presence/ | Presence/ | Number of | Increase in |
|---|---|---|---|---|
| | absence of | absence of | cycles to | resistance |
| | zirconium | deposited erbium | capacity | after 150 |
| | (amount | oxyhydroxide | retention | cycles |
| Battery | added) | (amount deposited) | of 70% | (mΩ) |
| A | Present | Present | 530 cycles | 2.5 mΩ |
| | (0.5 mol %) | (0.1 mol %) | | |
| Z1 | Present | Absent | 190 cycles | 14 mΩ |
| | (0.5 mol %) | | | |
| Z2 | Absent | Present | 350 cycles | 7 mΩ |
| | | (0.1 mol %) | | |
| Z3 | Absent | Absent | 190 cycles | 22 mΩ |

As can be seen from Table 1 above, Battery A showed a larger number of cycles to a capacity retention of 70% and a smaller increase in resistance after cycling than Batteries Z1 to Z3. A comparison between Batteries Z1 and Z3, in which no erbium oxyhydroxide was deposited, reveals that Battery Z1, which contained zirconium, showed a slightly smaller increase in resistance after 150 cycles than Battery Z3, which contained no zirconium, although this result is still unsatisfactory. Batteries Z1 and Z3 also showed extremely small numbers of cycles to a capacity retention of 70% irrespective of the presence or absence of zirconium. A comparison between Batteries Z2 and Z3, which contained no zirconium, reveals that Battery Z2, in which erbium oxyhydroxide was deposited, showed a larger number of cycles to a capacity retention of 70% and a smaller increase in resistance after cycling than Battery Z3, in which no erbium oxyhydroxide was deposited, although these results are still unsatisfactory.

Thus, simply incorporating zirconium into the lithium transition metal oxide or depositing erbium oxyhydroxide on the lithium transition metal oxide particles does not drastically reduce the increase in resistance after 150 cycles or significantly increase the number of cycles to a capacity retention of 70%. However, combining the incorporation of zirconium with the deposition of erbium oxyhydroxide on the lithium transition metal oxide particles (specifically, the deposition of erbium oxyhydroxide on and/or near the interfaces between the primary particles in the secondary particles of the lithium transition metal oxide) uniquely significantly increases the number of cycles to a capacity retention of 70% and drastically reduces the increase in resistance after 150 cycles.

Although the reason is not fully understood, a possible explanation is as follows. If zirconium is present in the lithium transition metal oxide and erbium (rare earth element) derived from erbium oxyhydroxide is deposited on and/or near the interfaces between the primary particles in the secondary particles of the lithium transition metal oxide, zirconium and erbium are both present near the interfaces between the primary particles. These elements form a stable structure on the surface of the lithium transition metal oxide particles and thus inhibit cracking of the lithium transition metal oxide particles.

Although the reaction mechanism by which a stable structure is formed on and/or near the interfaces between the primary particles if a rare earth compound is deposited on and/or near the interfaces is not fully understood, a possible explanation is as follows. If zirconium is present in the lithium transition metal oxide, it has a valence of 3 or 4 and thus has empty 4d orbitals. The 4f electrons, which are characteristic of rare earth elements, interact with the empty 4d orbitals and are attracted to the 4d orbitals. As a result, the electrons present in the 4d orbitals of zirconium stabilize the electronic state of the transition metals (nickel and, if present, other elements such as cobalt and manganese) present around zirconium. This reduces the decrease in the valence of the transition metals and thus maintains a stable structure on the surface of the lithium transition metal oxide.

### INDUSTRIAL APPLICABILITY

The present invention can be expected to find applications, for example, in power supplies for mobile information terminals such as cellular phones, laptop computers, and smart phones, power supplies for high-power applications such as electric vehicles, HEVs, and electric tools, and power supplies for storage applications.

### REFERENCE SIGNS LIST

1 nonaqueous electrolyte secondary battery

10 electrode assembly

11 positive electrode

12 negative electrode

16 separator

17 electrode container

1. A positive electrode active material for a nonaqueous electrolyte secondary battery, the positive electrode active material comprising:
a lithium transition metal oxide containing nickel and zirconium and comprising secondary particles, each secondary particle comprising an aggregate of primary particles; and
a rare earth compound deposited on and/or near interfaces between the primary particles.

2. The positive electrode active material for a nonaqueous electrolyte secondary battery according to claim 1, wherein the lithium transition metal oxide is represented by the formula LiₓNi_{y}Zr_{z}M_{(1-y-z)}O₂ (where M is at least one element selected from the group consisting of cobalt, manganese, and aluminum, 0.9<x<1.2, 0.3<y≦0.9, and 0.001≦z≦0.01).

3. The positive electrode active material for a nonaqueous electrolyte secondary battery according to claim 2, wherein the lithium transition metal oxide is represented by the formula LiₓNi_{y}Zr_{z}CoₐMn_{b}Al_{(1-y-z-a-b)}O₂ (where 0.9<x<1.2, 0.3<y≦0.9, 0.001≦z≦0.01, y-b>0.03, and 0≦b≦0.5).

4. The positive electrode active material for a nonaqueous electrolyte secondary battery according to claim 1, wherein the primary particles of the lithium transition metal oxide have a particle size of from 0.2 to 2 μm.

5. The positive electrode active material for a nonaqueous electrolyte secondary battery according to claim 1, wherein the rare earth compound is a rare earth hydroxide, a rare earth oxyhydroxide, or a rare earth oxide.

6. The positive electrode active material for a nonaqueous electrolyte secondary battery according to claim 1, wherein the rare earth compound contains a rare earth element selected from neodymium, samarium, and erbium.

7. A nonaqueous electrolyte secondary battery comprising:
a positive electrode comprising the positive electrode active material according to claim 1;
a negative electrode comprising a negative electrode active material capable of absorbing and releasing lithium;
a separator between the positive and negative electrodes; and
a nonaqueous electrolyte.

8. A positive electrode active material for a nonaqueous electrolyte secondary battery, the positive electrode active material comprising:
a lithium transition metal oxide containing nickel and zirconium and comprising secondary particles, each secondary particle comprising an aggregate of primary particles; and
a rare earth compound deposited on and/or near interfaces between the primary particles,
wherein the lithium transition metal oxide is represented by the formula LiₓNi_{y}Zr_{z}M_{(1-y-z)}O₂ (where M is at least one element selected from the group consisting of cobalt, manganese, and aluminum, 0.9<x<1.2, 0.3<y≦0.9, and 0.001≦z≦0.01),
wherein the primary particles of the lithium transition metal oxide have a particle size of from 0.2 to 2 μm,
wherein the rare earth compound is a rare earth hydroxide, a rare earth oxyhydroxide, or a rare earth oxide,
wherein the rare earth compound contains a rare earth element selected from neodymium, samarium, and erbium.
